(19) United States
(12) Patent Application Publication
(10) Pub. No.: US 2025/0056569 A1
(43) Pub. Date: Feb. 13, 2025

(54) NETWORK SLICING FOR SIDELINK DEVICES

(71) Applicant: Google LLC, Mountain View, CA (US)

(72) Inventors: Jibing Wang, San Jose, CA (US); Aamir Akram, San Jose, CA (US); Erik Stauffer, Mountain View, CA (US)

(21) Appl. No.: 18/722,871

(22) PCT Filed: Jan. 27, 2023
(86) PCT No.: PCT/US2023/011756

§ 371 Date: Jun. 21, 2024

Related U.S. Application Data
(60) Provisional application No. 63/303,776, filed on Jan. 27, 2022.

(51) Int. Cl. H04W 72/25; H04B 17/318

(52) U.S. Cl. CPC H04W 72/25; H04B 17/328

(57) ABSTRACT

A system and method of network slicing for sidelink devices. The method includes establishing a sidelink connection with a second UE (104). The method includes receiving, from the second UE (104) via the sidelink connection (119), a first request for a network slice of a physical network (106). The method includes transmitting, responsive to receiving the first request for the network slice, a first message to the physical network over a first network slice between the first UE (102) and the physical network (106) to request the physical network to establish a second network slice communicatively coupling the second UE (104) to the physical network (106) via the sidelink connection (119).

### CROSS-REFERENCE TO RELATED APPLICATIONS

This application claims the benefit of U.S. Provisional Patent Application No. U.S. 63/303,776, filed 27 Jan. 2022 the disclosure of which is incorporated herein by reference in its entirety.

### TECHNICAL FIELD

The present disclosure relates generally to wireless communication, and more particularly, to systems and methods of network slicing for sidelink devices.

### BACKGROUND

The Third Generation Partnership Project (3GPP) is currently in the process of specifying a new Radio Interface called 5G New Radio (5G NR) as well as a Next Generation Packet Core Network (NG-CN or NGC). The 5G NR architecture will have three components: a 5G Radio Access Network (5G-RAN), a 5G Core Network (5GC), and a User Equipment (UE). In order to facilitate the enablement of different data services and requirements, the 3GPP 5G NR cellular network supports network slicing, which enables the multiplexing of virtualized and independent logical networks on the same physical network infrastructure.

As data and bandwidth allotments have increased for end-users, wireless tethering via a sidelink connection has become a more viable and useful option for accessing the Internet through cellular networks. However, tethering technology typically is not configured to realize recent advancements in cellular networks.

One such advancement is network slicing, which allows for network services to be customized based on the requirements of different use cases. The services provided by a 3GPP 5G NR cellular network can be implemented using a network slice, which is instantiated and managed by the network management system of the 5G NR network. A network slice defines a class of service in a cellular network and can be viewed as an end-to-end logical network that spans multiple portions of the cellular network. Each network slice provides service qualities tailored to the use case associated with the network slice, such as low latency, guaranteed bandwidth, support for long-battery-life Internet of Things (IoT) devices, and so on. Also, a network slice can have dedicated resources in the cellular network of a single network operator or across the cellular network of multiple network operators. An end-to-end network slice includes a Radio Access Network (RAN) slice and/or a core network (CN) slice. Thus, network slicing provides isolation of RAN and core resources to support guaranteed service levels for devices and services.

### SUMMARY

Wireless or wired tethering technology enables devices that may not have hardware and/or software resources for establishing a connection with a cellular network to still access the cellular network through another device. For example, a second UE device, such as a wearable device (e.g., watch, headset, wireless earbuds, fitness tracker, blood pressure monitor, etc.) or a non-wearable device (e.g., a tablet, notebook computer, etc.) may be unable to connect with a cellular network because the second UE device lacks the hardware and/or software resources to connect with the cellular network. As examples, the currently-available cellular network is outside of a radio frequency (RF) range capability of the second UE device, or the second UE device currently has low battery power. However, the second UE device can establish a sidelink connection with a first UE device (e.g., smartphone) via a sidelink interface (e.g., PC5, Bluetooth, WiFi, etc.), where the first UE device is capable of establishing a connection with the cellular network via its cellular air interface (sometimes referred to as, “Uu interface”). The sidelink connection allows the second UE device (sometimes referred to as, “sidelink UE device”) to access the cellular network's services through the network connection of the first UE device (sometimes referred to as, “host UE device”).

Thus, there is an opportunity to develop new slice scenarios to accommodate dynamic connectivity for a wide variety of sidelink UE devices, which offer support for consistent Quality of Service (QOS) performance over the wireless sidelink and Uu interfaces of the sidelink UE device and the host UE device. To support the increasing number of sidelink UE devices that are indirectly connecting to the cellular network, users would also benefit from an improvement to the capacity of the cellular network.

Aspects of the present disclosure address the above-noted and other deficiencies by implementing network slicing for sidelink UE devices. As discussed in greater detail below, a sidelink UE device (e.g., wearable device or non-wearable device) negotiates with a host UE device (e.g., smart phone) to establish a sidelink channel (e.g., PC5, Bluetooth, WiFi) between the host UE device and the sidelink UE device. The host UE device, either before or after establishing the sidelink channel, connects to a cellular network over a first network slice using its Uu interface. The host UE device receives, from the sidelink UE device via the sidelink channel, a request for a network slice of the cellular network. In response, the host UE device transmits a request to the cellular network over the first network slice (i.e., over the host UE device's network slice) to request the cellular network to establish a second network slice for the sidelink UE device. The cellular network establishes a second network slice as an end-to-end connection from the cellular network to the sidelink UE device, where a first portion of the connection is between the cellular network and the host UE device over the host UE device's cellular air interface, and a second portion of the connection is between the host UE device and the sidelink UE device over the sidelink channel. In this configuration, the host UE device and the cellular network communicate with each other over the second network slice with the host UE device acting as an intermediary and redirecting (e.g., forwarding) the messages that it receives over the second network slice towards the sidelink UE device.

The cellular network may establish the sidelink UE device's second network slice (which passes through the cellular air interface and sidelink channel of the host UE device) as a separate network slice with slice resources separate from the first network slice for the host UE device. In this implementation, the sidelink UE device's second network slice reduces the number of network slices available for the host UE device because a cellular network limits a host UE device to a maximum number (e.g., 8) of network slices. Alternatively, the cellular network may establish the second network slice for the sidelink UE device as a sub-slice of the first network slice for the host UE device. Establishing a network slice as a sub-slice may increase the host UE device's capacity to be an intermediary for sidelink UE devices because the cellular network does not limit the number of sub-slices that are available per each network slice.

In another aspect, the sidelink UE device determines timing for a modification of a set of network slices for the sidelink UE device to change from a network slice that uses a sidelink connection to another network slice that does not use the sidelink connection. For example, the sidelink UE device may detect (e.g., via a received signal strength indicator (RSSI)) that the signal strength of the sidelink channel between the sidelink UE device and the host UE device is weak or weakening. In response, the sidelink UE device may transmit a request to the host UE device via the sidelink channel, where the request is to modify a set of network slices for the sidelink UE device to change from (a) a network slice that uses a sidelink connection to (b) another network slice that does not use the sidelink connection. In response to receiving the request from the sidelink UE device, the host UE device may send a request to the cellular network to (1) move a control plane message of the second network slice to a third network slice, and/or (2) a request to remove the sidelink connection from a user plane of the second network slice. As such, the third network slice connects the sidelink UE device to the cellular network via a cellular air interface of the sidelink UE device and without using the sidelink channel.

### BRIEF DESCRIPTION OF THE DRAWINGS

The described embodiments and the advantages thereof may best be understood by reference to the following description taken in conjunction with the accompanying drawings. These drawings in no way limit any changes in form and detail that may be made to the described embodiments by one skilled in the art without departing from the spirit and scope of the described embodiments.

FIG. 1 is a block diagram depicting an example environment for implementing separate network slices for a host UE device 102 and a sidelink wireless device 104, according to some embodiments;

FIG. 2 is a signaling diagram depicting an example method of implementing separate network slices for the host UE device 102 and the sidelink wireless device 104 in FIG. 1, according to some embodiments.

FIG. 3 is a block diagram depicting an example environment for implementing a network slice for the host UE device 102 and a sub-slice of the network slice for the sidelink wireless device 104, according to some embodiments:

FIG. 4 is a signaling diagram depicting an example method of implementing a network slice for the host UE device 102 and a sub-slice of the network slice for the sidelink communication device 104 in FIG. 3, according to some embodiments:

FIG. 5 is a block diagram depicting an example environment for modifying a set of network slices for the sidelink UE device 104 to change from a network slice that uses a sidelink connection to another network slice that does not use the sidelink connection, according to some embodiments:

FIG. 6 is a signaling diagram depicting an example method of modifying a set of network slices for the sidelink UE device 104 in FIG. 5 to change from a network slice that uses a sidelink connection to another network slice that does not use the sidelink connection, according to some embodiments:

FIG. 7 is a block diagram depicting an example device diagram of a UE device or a communication device, according to some embodiments:

FIG. 8 is a flow diagram depicting a method for implementing network slicing by a host UE device, according to some embodiments:

FIG. 9 is a flow diagram depicting a method for implementing network slicing by a host UE device, according to some embodiments; and

FIG. 10 is a flow diagram depicting a method for implementing network slicing by a sidelink wireless device 104, according to some embodiments.

### DETAILED DESCRIPTION

For ease of illustration, the following techniques are described in an example context in which one or more UE devices and RANs implement one or more radio access technologies (RATs) including at least a Fifth Generation (5G) New Radio (NR) standard (e.g., Third Generation Partnership Project (3GPP) Release 15, 3GPP Release 16, etc.) (hereinafter, “5G NR” or “5G NR standard”). However, the present disclosure is not limited to networks employing a 5G NR RAT configuration, but rather the techniques described herein can be applied to any combination of different RATs employed at the UE devices and the RANs. Also, the present disclosure is not limited to the examples and context described herein, but rather the techniques described herein can be applied to any network environment where a host UE device implements network slicing for sidelink UE devices.

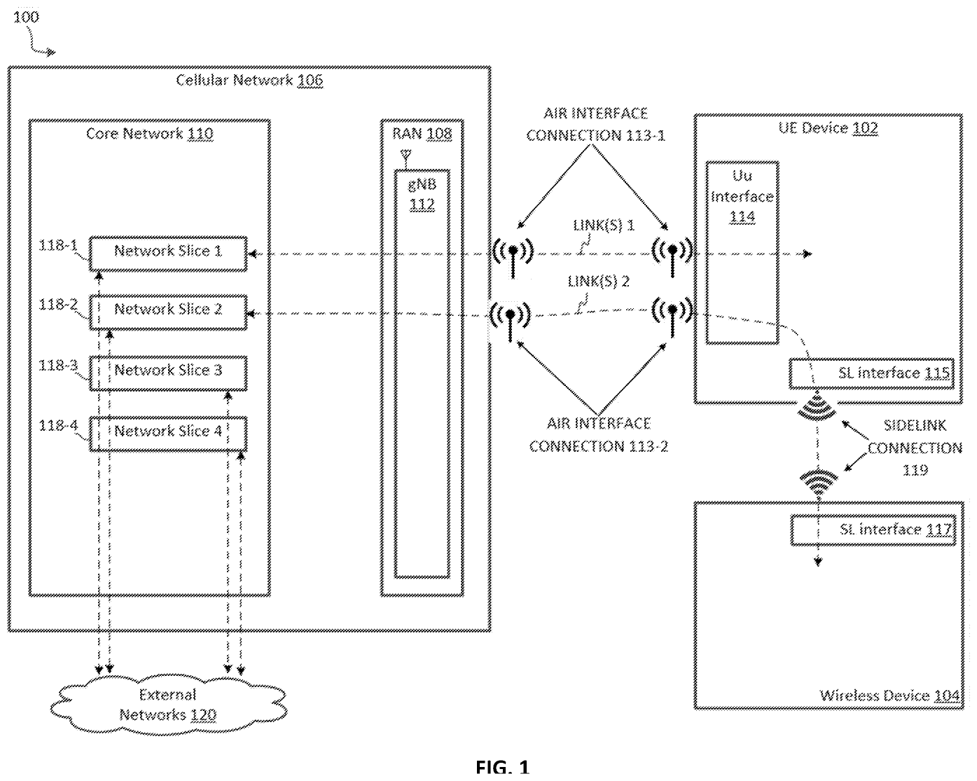

FIG. 1 is a block diagram depicting an example environment for implementing separate network slices for a host UE device 102 and a sidelink wireless device 104, according to some embodiments. The environment 100 includes a cellular network 106, a UE device 102 (sometimes referred to as, “host UE device 102”), and a wireless device 104 (sometimes referred to as, “sidelink UE device 104” or a “sidelink wireless device 104”). The present disclosure is not limited to a cellular network, and the techniques described herein apply to other types of wireless communication systems. The cellular network 106 includes a radio access network (RAN) 108 and a core network 110. The environment 100 includes an external network 120, such as the Internet or a public switched telephone network (PSTN), that is coupled to the cellular network 106 via the core network 110. The cellular network 106 may include additional components not shown in FIG. 1.

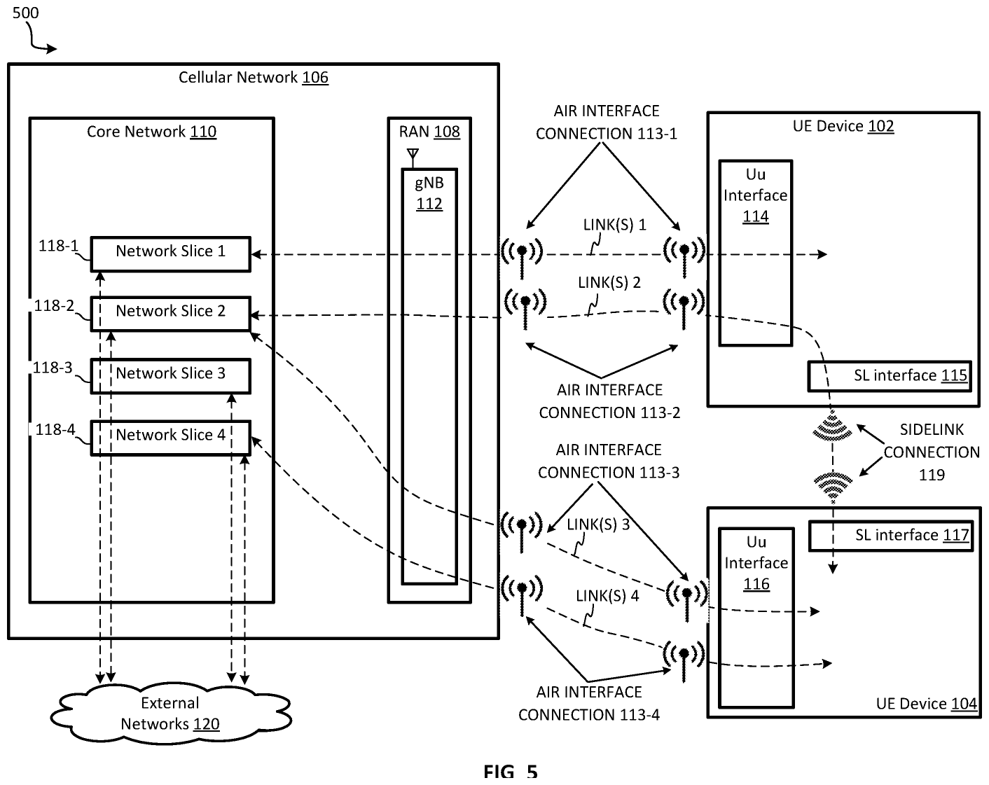

The UE devices 102, 104 may each represent any of a variety of electronic devices capable of wired and/or wireless communications, such as a smartphone, a tablet computer, a notebook computer, a desktop computer, a wearable device (e.g., smartwatch, headset, wireless earbuds, fitness tracker, blood pressure monitor, smart jewelry, smart clothing, smart glasses, etc.), an automobile or other vehicle employing wireless communication services (e.g., for navigation, provision of entertainment services, in-vehicle mobile hotspots, etc.), a gaming device, a media device, an IoT device (e.g., sensor node, controller/actuator node, or a combination thereof), and another device capable of wired and/or wireless communication. Depending on whether the sidelink device 104 has a wireless sidelink interface (see FIGS. 1, 3, and 5) with or without a Uu interface (see FIG. 5), the communication device 104 may be called a wireless communication device or a UE device.

The RAN 108 is accessible using, for example, a 5G NR RAT and is to at least the core network 110. A RAN 108 implementing a 5G NR RAT may be referred to as a 5G NR RAN or an NR RAN. One example of a core network 110 in a 5G cellular network is a Fifth-Generation Core (5GC) network.

Each RAN 108 includes one or more base stations 112 (shown in FIG. 1 as “gNB”) operable to wirelessly communicate with the UE devices 102, 104 within signal range. A base station 112 may be implemented as an integrated gNB base station or as a distributed base station with a central unit (CU) and one or more distributed units (DU) and optionally one or more remote units (RUs). Irrespective of base station architecture, each base station 112 supports at least one “cell” of coverage for the RAN 108. A base station 112 defines a macrocell, microcell, small cell, picocell, or the like, or any combination thereof. Consistent with the terminology employed by the 5G NR standard, a base station implementing a 5G NR RAT is referred to herein as “5G NodeB” or “gNB”. The base station operates as an “air interface” to establish radio frequency (RF) wireless communication links (e.g., an upstream link or uplink toward a CN, a downstream link or downlink toward a UE) with UE devices 102, 104, which can be implemented as any suitable type of wireless communication link. These wireless communication links then serve as data paths (including control information) between the UE devices 102, 104 and the core network 110, which is coupled to the one or more of the external networks 120, for providing various services to the UE devices 102, 104. Examples of these services include voice or data services via packet-switched networks, messaging services such as simple messaging service (SMS) or multimedia messaging service (MMS), audio, video, or multimedia content delivery, presence services, and so on. Multiple wireless communication links from multiple base stations 112 can be configured for Coordinated Multipoint (COMP) communication with the UE devices 102, 104. A base station can aggregate multiple wireless communication links in a carrier aggregation to provide a higher data rate for the UE devices 102, 104. The base station can configure multiple wireless communication links for single-RAT or multi-RAT dual connectivity (MR-DC).

The core network 110 establishes one or more network slices 118 of the cellular network 106, e.g., network slice 118-1 (shown in FIG. 1 as, “network slice 1”), network slice 118-2 (shown in FIG. 1 as, “network slice 2”), network slice 118-3 (shown in FIG. 1 as, “network slice 3”), and network slice 118-4 (shown in FIG. 1 as, “network slice 4”). Each network slice 118 provides isolation of RAN and core resources of the cellular network 106 to support guaranteed service levels for devices and services. As such, each network slice 118 is separate from the other network slices 118 of the cellular network 106. A network slice 118 communicatively couples the UE device 102 and/or UE device 104 to the cellular network 106 over one or more wireless communication links to allow the UE device 102 and/or UE device 104 to access the RAN and core resources of the network slice 118 over its corresponding links. As used herein, a wireless communication link (or simply, “link”) may correspond to a set of wireless communication links, such as one or more of an upstream data link, an upstream control link, a downstream data link, or a downstream control link. As shown in FIG. 1, a network slice 118 may be extended into external networks 120 to connect the UE devices 102 and/or UE device 104 in the external network 120 to the cellular network 106.

Examples of network slices 118 include network slices configured for 5G NR enhanced Mobile Broadband (eMBB), 5G Ultra-Reliable Low Latency Communications (URLLC), 5G NR massive Machine Type Communications (mMTC), massive Internet-of-Things (MIT), and so on. The cellular network 106 may support any number and combination of network slices 118, including those not illustrated in FIG. 1.

For each network slice, the core network 110 defines a single network slice selection assistance information (S-NSSAI) to uniquely identify the network slice. The S-NSSAI for a network slice contains two components: an SST (Slice/Service Type) and an optional SD (Slice Differentiator).

The UE device 102 includes an air interface 114 (shown in FIG. 1 as, “Uu interface 114”) that allows the UE device to communicate with the cellular network 106 over the one or more network slices 118 that the cellular network 106 establishes for the UE device 102. An air interface may include an antenna, a RF modem, an RF radio, and/or a plurality of channels or ports, etc.

The UE device 102 includes a sidelink interface 115 (shown in FIG. 1 as, “SL interface 115”) and UE device 104 includes a sidelink interface 117 (shown in FIG. 1 as, “SL interface 117”). The sidelink interfaces allow the UE devices 102, 104 to directly communicate with one another using a wired connection technology (e.g., Universal Serial Bus (USB) connection) and/or a wireless connection technology (e.g., PC5, Bluetooth® (BT), Zigbee®, WiFi, Near Field Communication (NFC)).

Still referring to FIG. 1, the UE device 102 and wireless device 104 may negotiate via the SL interfaces 115, 117 to establish a sidelink connection 119 between the UE devices 102, 104. For example, the UE device 104 may transmit (e.g., send) a message to the UE device 102 via the sidelink connection to request the UE device 104 to establish a sidelink connection between the UE devices 102, 104. In response, the UE device 102 may establish the sidelink connection between the UE devices 102, 104 and transmit a message to the UE device 104 indicating establishment of the sidelink connection. In some embodiments, the UE device 102 may initiate the sidelink connection between the UE devices 102, 104.

The UE device 102 transmits a message to the cellular network 106 (sometimes referred to as, “physical network”) via its Uu interface 114 to request the cellular network 106 to establish a network slice. The network slice communicatively couples the UE device 102 to the cellular network 106. As an example, the cellular network 106, in response to receiving the request, establishes network slice 118-1 (sometimes referred to as, “first network slice”) to communicatively couple the UE device 102 to the cellular network 106 via link 1 over the air interface connection 113-1.

The UE device 104 transmits a message to the UE device 102 via the sidelink interface to request a network slice from the cellular network 106. The UE device 102 determines, based on the request from the UE device 104, to request the cellular network 106 to establish a network slice for the UE device 104 as a separate network slice (e.g., a network slice that is separate from the network slices established for the UE device 102). The request from the UE device 104 includes information (e.g., bits) indicating that the UE device 104 is requesting a separate network slice (as opposed to a network sub-slice), a device type identifier (e.g., smartwatch, etc.) of the UE device 104, and/or bandwidth requirements associated with the UE device 104.

A data flow over a network slice (e.g., network slice 118-1) is associated with a first set of quality of service (QOS) parameters and a data flow over a network slice (e.g., network slice 118-2) is associated with a second set of QoS parameters. Sometimes, the first Qos parameters are different than the second QoS parameters. At other times, the first Qos parameters and the second QoS parameters are the same.

The UE device 102 transmits a message to the cellular network 106 over the network slice 118-1 of the UE device 102 to request the cellular network 106 to establish a separate network slice (e.g., a network slice that is separate from the network slices established for the UE device 102). The separate network slice communicatively couples the UE device 104 to the cellular network 106 via the sidelink connection. The cellular network 106, in response to receiving the request, establishes network slice 118-2 (sometimes referred to as, “second network slice”) to communicatively couple the UE device 104 to the cellular network 106 with the UE device 102 acting as an intermediary device. In other words, the network slice 118-2 is an end-to-end connection (shown in FIG. 1 as, “link 2”) between the cellular network 106 and the UE device 104, where a first portion of the end-to-end connection is between the cellular network 106 and the UE device 102 over the air interface connection 113-2, and a second portion of the end-to-end connection is between the UE device 102 and the UE device 104 over the sidelink connection 119.

The cellular network 106 transmits a message to the UE device 102 indicating that the cellular network 106 established the network slice 118-2 for the UE device 104. The message includes a S-NSSAI that uniquely identifies the network slice 118-2. The UE device 102 transmits a message to the UE device 104 via the sidelink connection that includes the S-NSSAI.

The cellular network 106 and the UE device 102 communicate with each other using non-access stratum (NAS) signaling. The NAS is the highest stratum of the control plane between the UE device 102 and the RAN 108. Main functions of the protocols that are part of the NAS support mobility of the UE device 102 and support session management procedures to establish and maintain IP connectivity with the UE device 102. Referring to FIG. 1, the UE device 102 receives a first message (e.g., a NAS message) from the cellular network 106, where the first message is associated with a network slice (e.g., network slice 118-1) for the UE device 102. The UE device 102 receives a second message (e.g., a NAS message) from the cellular network 106, where the second message is associated with a network slice (e.g., network slice 118-2) for the UE device 104. The first message and the second message are each associated with a control plane message or a user plane message.

The UE device 102 selects (e.g., filters) the received messages (e.g., NAS messages) that are associated with and/or directed to the UE device 104. The UE device 102 redirects (e.g., forwards, relays) the selected messages (e.g., second message) to the UE device 104 via the sidelink connection 119 without redirecting the other messages (e.g., first message) to the UE device 104.

The set of network slices for a UE device (e.g., UE device 102, UE device 104) can be modified (e.g., changed) at any time while the UE device is registered with the cellular network 106, and may be initiated by the cellular network 106, by the UE device 102, or by the wireless device 104, under certain conditions as described below.

The cellular network 106, based on local policies, subscription changes and/or UE mobility and/or UE dispersion data classification, or operational reasons (e.g. a network slice instance is no longer available, or load level information, or service experience for a network slice can no longer be supported, or a new network slice instance can be provided by the network data analytics function (NWDAF)) may change the set of network slice(s) to which the UE device is registered and provide the UE device with a new Registration Area and/or Allowed NSSAI. The network may change the mapping of the Allowed NSSAI to home public land mobile network (HPLMN) HPLMN S-NSSAIs for each Access Type over which the UE device is registered. In addition, the cellular network 106 may provide the Configured NSSAI for the Serving Public Land Mobile Network (PLMN), the associated mapping information, and the rejected S-NSSAIs. The cellular network 106 may perform such a change over each Access Type during a Registration procedure or trigger a notification towards the UE device of the change of the Network Slices using a UE Configuration Update procedure. The AMF provides the UE device with: (1) an indication that the acknowledgement from the UE device is required, (2) configured NSSAI for the Serving PLMN (if required), rejected S-NSSAI(s) (if required), and Tracking Area Identity (TAI) list, and (3) the new Allowed NSSAI with the associated mapping of Allowed NSSAI for each Access Type (as applicable) unless the AMF cannot determine the new Allowed NSSAI (e.g. all S-NSSAIs in the old Allowed NSSAI have been removed from the Subscribed S-NSSAIs).

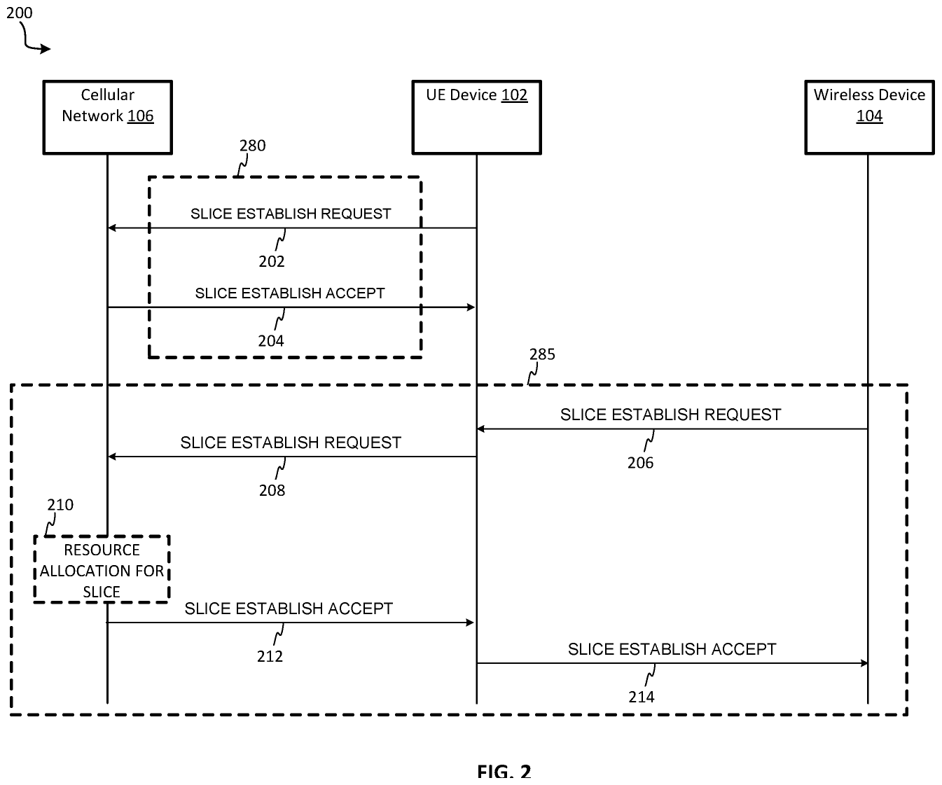

FIG. 2 is a signaling diagram depicting an example method of implementing separate network slices for the host UE device 102 and the sidelink wireless device 104 in FIG. 1, according to some embodiments. The environment 200 includes the UE device 102, the UE device 104, and the cellular network 106 in FIG. 1. At operation 280, the UE device 102 establishes a network slice according to operations 202 and 204. At operation 202, the UE device 102 transmits a message (labeled in FIG. 2 as, “Slice Establish Request”) to the cellular network 106 via Uu interface 114 to request the cellular network 106 to establish a network slice to communicatively couple the UE device 102 to the cellular network 106.

The Slice Establish Request at operation 202 includes a Registration Request Type, a 5GS MobileIdentity, non-Current Native NAS key set identifier, 5G Mobility management (5GMM) Capability, UE Security Capability, Requested NSSAI, last Visited Registered TAI, s1 UE Network Capability, uplink Data Status, Protocol Data Unit (PDU) Session Status, Mobile Initiated Connection Only (MICO) Indication, UE Status, additional Global Unique temporary Identifier (GUTI), allowed PDU Session Status, UE Usage Setting, requested Discontinuous Reception (DRX) Parameters, Evolved Packet System (EPS) NAS Message Container, Local Area Data Network (LADN) Indication, payload Container Type, payload Container, Network Slicing Indication, 5GS Update Type, NAS Message Container, and/or EPS Bearer Context Status.

At operation 204, the cellular network 106 establishes network slice 118-1 to communicatively couple the UE device 102 to the cellular network 106 via link 1. The cellular network 106 transmits a message (labeled in FIG. 2 as, “Slice Establish Accept”) via Uu interface 114. The Slice Establish Accept at operation 204 includes Extended protocol discriminator, Security header type, Spare half octet, Registration accept message identity, 5GS registration result, 5G-GUTI, Equivalent PLMNs, TAI list, Allowed NSSAI, Rejected NSSAI, Configured NSSAI, 5GS network feature support, PDU session status, PDU session reactivation result, PDU session reactivation result error cause, LADN information, MICO indication, Network slicing indication, Service area list, T3512 value, Non-3GPP de-registration timer value, T3502 value, Emergency number list, Extended emergency number list, SOR transparent container, and/or EAP message.

At operation 285, the UE device 102 establishes a network slice according to operations 206, 208, 210, 212, and 214. At operation 206, the UE device 104 transmits a message (labeled in FIG. 2 as, “Slice Establish Request”) to the UE device 102 via the sidelink connection (e.g., across SL interfaces 115, 117) to request a network slice of the cellular network 106. The Slice Establish Request at operation 206 includes Qos characteristics and/or sidelink connection characteristics (e.g., delay, data rate, packet loss rate).

At operation 208, the UE device 104 transmits a message (labeled in FIG. 2 as, “Slice Establish Request”) to the cellular network 106 over the network slice 118-1 of the UE device 102 to request the cellular network 106 to establish a separate network slice (e.g., a network slice that is separate from network slice 118-1) to communicatively couple the UE device 104 to the cellular network 106 via the sidelink connection. The Slice Establish Request 208 at operation 208 includes the contents from the message that the UE device 102 received at operation 206. In some embodiments, operations 202 and 204 take place after operations 206 and 208.

At operation 210, the cellular network 106 allocates resources of the cellular network 106 for the network slice 118-2 when physical network resources are available to configure a network slice as requested. If the cellular network 106 determines that physical network resources are not available to configure a network slice as requested, then the cellular network 106 transmits a message (not shown in FIG. 2) indicating that the cellular network 106 rejects the request.

The cellular network 106 establishes the network slice 118-2 as an end-to-end connection between the cellular network 106 and the UE device 104, where a first portion (shown in FIG. 1 as, “link 2”) of the end-to-end connection is between the cellular network 106 and the UE device 102 over the Uu interface 114, and a second portion of the end-to-end connection is between the UE device 102 and the UE device 104 over the sidelink connection.

At operation 212, the cellular network 106 transmits a message (labeled in FIG. 2 as, “Slice Establish Accept”) to the UE device indicating that the network slice 118-2 is established for the UE device 104. The Slice Establish Accept at operation 212 includes a first set of information indicating that the slice terminates at the UE 104 and/or a second set of information indicating that the slice has the sidelink connection as a part of the end-to-end connection between the cellular network 106 and the UE device 104.

At operation 214, the UE device 102 transmits a message (labeled in FIG. 2 as, “Slice Establish Accept”) to the UE device 104 indicating that the network slice 118-2 is established for the UE device 104. The Slice Establish Accept at operation 214 includes the contents from the message that the UE device 102 received at operation 212.

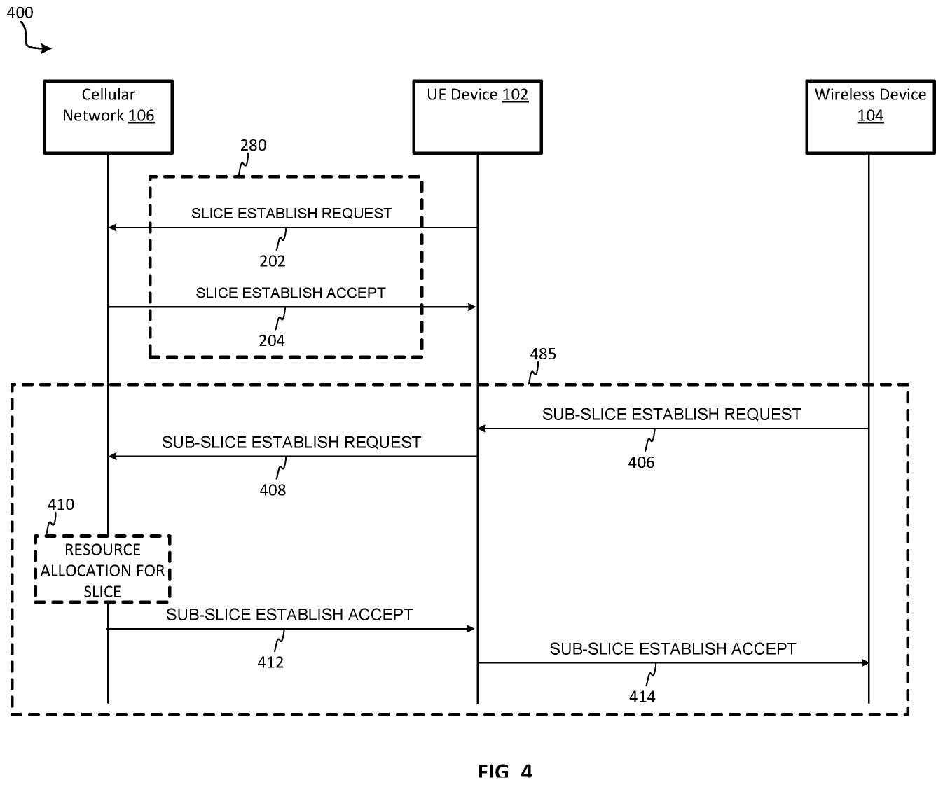

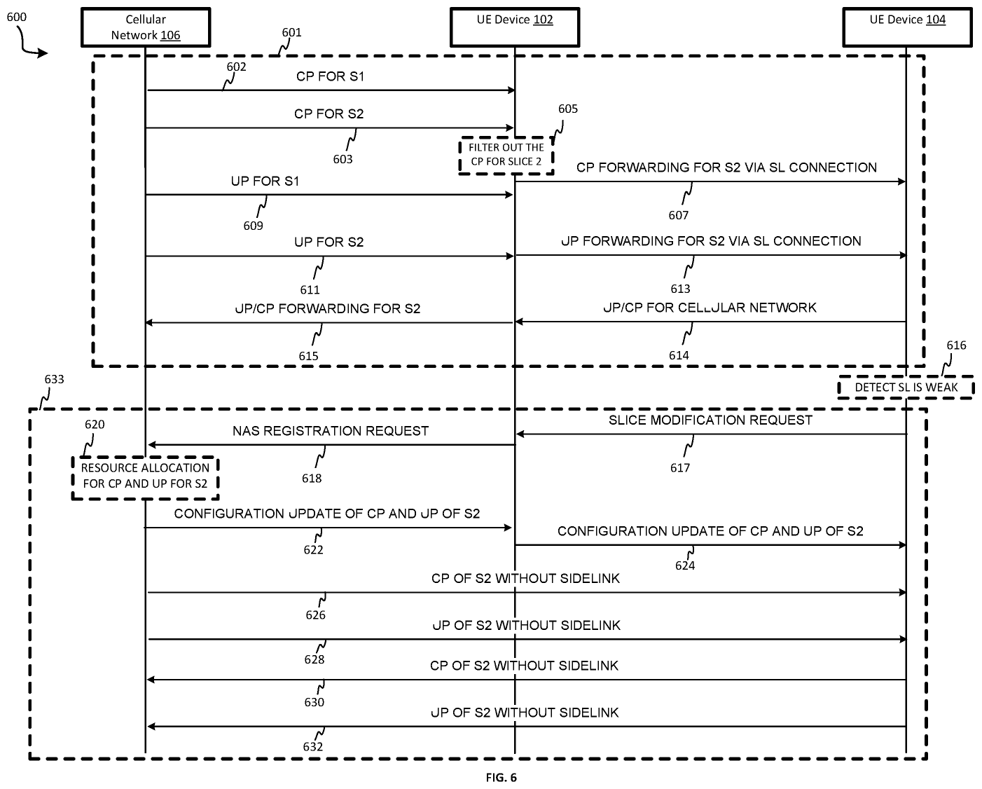

It is appreciated that the blocks in method 200 may be performed in an order different than presented, that not all of the blocks in method 200 may be performed, and the blocks may be combined with other methods presented herein. For example, operation 280 can be followed (or preceded) by either operation 285 or operation 485 in FIG. 4. As another example, operation 280 may precede operation 285, and then followed by operation 601 (a control plane/user plane (CP/UP) message filtering and forwarding procedure) in FIG. 6, and then followed by operation 633 (e.g., a slice modification procedure) in FIG. 6. As another example, operation 280 may precede operation 485 in FIG. 4, and then followed by operation 601 in FIG. 6, and then followed by operation 633 in FIG. 6.

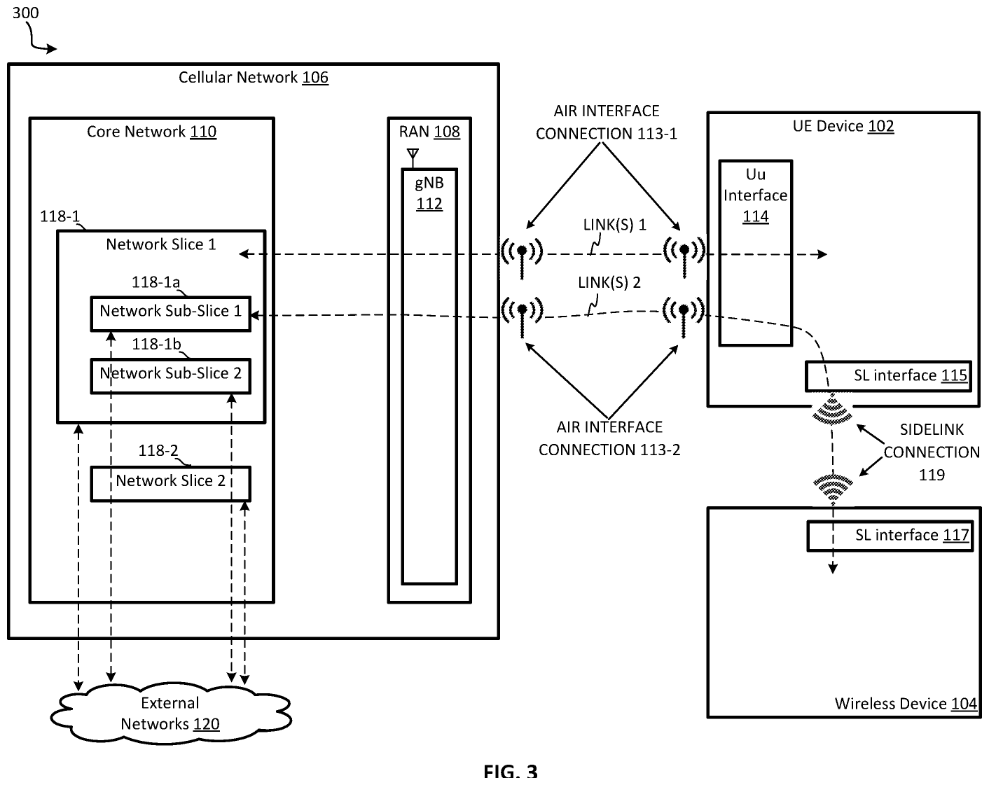

FIG. 3 is a block diagram depicting an example environment for implementing a network slice for the host UE device 102 and a sub-slice of the network slice for the sidelink UE device 104 in FIG. 1, according to some embodiments. Elements with the same reference numbers as FIG. 1 refer to the same or similar features, and FIG. 3 shows how a network slice may be divided into network sub-slices.

In other words, instead of configuring a separate slice for UE device 104 per FIG. 1, the core network 110 may establish one or more network sub-slices of an existing network slice. For example, the core network 110 may establish network sub-slice 118-1a (shown in FIG. 1 as, “network sub-slice 1”) of the network slice 118-1 and/or network sub-slice 118-1b (shown in FIG. 1 as, “network sub-slice 2”) of the network slice 118-1. Because network slices (and network sub-slices) consume network resources, the core network 110 only establishes a network slice in response to receiving a request from a user device. Therefore, if network slices or network sub-slices shown in FIG. 3 are never reserved for a user device, then those network slices should be disregarded because the core network 110 would not establish a static network slice. In embodiments where network resources are less limited, the core network 110 may establish static network slices and static network sub-slices.

Each network sub-slice of a network slice provides further isolation of RAN and core resources of the cellular network 106 to support guaranteed service levels for devices and services. As such, each network sub-slice is separate from the other network sub-slices within the same slice and separate from the other network slices of the cellular network 106. That is, a slice can have multiple sub-slices, and each sub-slice can have its own service level and QoS that are less strenuous than the slice's service level and QoS, and can be separated from another sub-slice of the same slice. A network sub-slice communicatively couples the UE device 102 and/or the UE device 104 to the cellular network 106 over one or more wireless communication links (e.g., an upstream link, a downstream link) to allow the UE device 102 and/or the UE device 104 to access the RAN and core resources of the network sub-slice 118 over its corresponding links. Establishing a network slice with a sub-slice increases the capacity of the UE device 102 to be an intermediary for the UE device 104 because the cellular network 106 does not limit the number of network sub-slices that are available per each network slice.

For each network sub-slice (e.g., network sub-slice 118-1a, network sub-slice 118-1b), the core network 110 defines a single network sub-slice selection assistance information (S-NSSSAI) to uniquely identify the network sub-slice and the network slice (sometimes referred to as, “parent network slice”) associated with the network sub-slice. The S-NSSSAI for a network sub-slice contains three components: an SST (Slice/Service Type) and a SS ID (Sub-Slice Identifier). For network sub-slice 118-1, for example, the core network 110 may define an S-NSSSAI that includes an SST that uniquely identifies the network sub-slice 118-1 and an SS ID that uniquely identifies the network sub-slice 118-1a.

A network sub-slice (e.g., network sub-slice 118-1a, network sub-slice 118-1b) may be associated with a peak data rate associated with its parent network slice (e.g., network slice 118-1). For example, the peak data rate of a network sub-slice may be less than the peak data rate of its parent network slice. A network sub-slice may be associated with a user-experience metric (e.g., data throughput, delay budget, packet error rates) associated with its parent network slice. In some embodiments, a network sub-slice is associated with a latency associated with its parent network slice. For example, the latency of a network sub-slice may be greater than the latency of its parent network slice. A network sub-slice may be associated with a mobility metric (e.g., data interruption time, mobility failure) associated with its parent network slice.

In some embodiment, a data flow over a network sub-slice (e.g., network sub-slice 118-1a) is associated with a first set of quality of service (QOS) parameters and a data flow over a network sub-slice (e.g., network sub-slice 118-1b) is associated with a second set of QoS parameters. In some embodiments, the first QoS parameters are different than the second QoS parameters. For example, the first QoS parameter may be greater than the second QoS parameter, or the second QoS parameter may be greater than the first QoS parameter. In some embodiments, the first QoS parameters and the second QoS parameters are the same.

Still referring to FIG. 3, the UE device 104 transmits a message to the UE device 102 via the sidelink interface to request a network slice of the cellular network 106. The UE device 102 determines, based on the request from the UE device 104, to request the cellular network 106 to establish a network sub-slice (instead of a separate network slice) for the UE device 104. The UE device 102 transmits a message to the cellular network 106 via Uu interface 114 to request the cellular network 106 to establish a network sub-slice (instead of a separate network slice as shown in FIGS. 1-2) to communicatively couple the UE device 104 to the cellular network 106. The cellular network 106, in response to receiving the request, establishes the network sub-slice 118-1a to communicatively couple the UE device 104 to the cellular network 106 with the UE device 102 acting as an intermediary device. In other words, the network sub-slice 118-1a is an end-to-end connection between the cellular network 106 and the UE device 104, where a first portion (shown in FIG. 3 as, “link 2”) of the end-to-end connection is between the cellular network 106 and the UE device 102 over the UE interface 114, and a second portion of the end-to-end connection is between the UE device 102 and the UE device 104 over the sidelink connection.

The cellular network 106 transmits a message to the UE device 102 indicating that the network sub-slice 118-1a is established for the UE device 104. The message includes a S-NSSAI that uniquely identifies the network sub-slice 118-1a. The UE device 102 transmits a message to the UE device 104 via the sidelink connection that includes the S-NSSAI. The UE device 104 uses the S-NSSAI to transmit messages to the cellular network 106 over the network sub-slice 118-1a.

FIG. 4 is a signaling diagram depicting an example method of implementing a network slice for the host UE device 102 and a sub-slice of the network slice for the sidelink UE wireless 104 in FIG. 3, according to some embodiments. The environment 400 includes the UE device 102, the UE device 104, the cellular network 106 in FIG. 3.

As explained with reference to FIG. 2, at operation 280, the UE device 102 establishes a network slice according to operations 202 and 204.

At operation 485, the UE device 102 establishes a network sub-slice (instead of a network slice) according to operations 406, 408, 410, 412, and 414. At operation 406, the UE device 104 transmits a message (labeled in FIG. 4 as, “Sub-Slice Establish Request”) to the UE device 102 via the sidelink connection (e.g., across SL interfaces 115, 117) to request a network sub-slice of the cellular network 106. The Slice Establish Request at operation 406 includes QoS characteristics and/or sidelink connection characteristics (e.g., delay, data rate, packet loss rate).

At operation 408, the UE device 104 transmits a message (labeled in FIG. 4 as, “Sub-Slice Establish Request”) to the cellular network 106 over the network sub-slice 118-1a of the UE device 102 to request the cellular network 106 to establish a network sub-slice to communicatively couple the UE device 104 to the cellular network 106 via the sidelink connection. In some embodiments, operations 402 and 404 take place after operations 406 and 408. The Sub-Slice Establish Request at operation 408 includes QoS characteristics and/or sidelink connection characteristics (e.g., delay, data rate, packet loss rate).

At operation 410, the cellular network 106 allocates resources of the cellular network 106 for the network sub-slice 118-1a when physical network resources are available to configure a network sub-slice as requested. If the cellular network 106 determines that physical network resources are not available to configure a network sub-slice as requested, then the cellular network 106 transmits a message (not shown in FIG. 4) indicating that the cellular network 106 rejects the request.

The cellular network 106 establishes the network sub-slice 118-1a as an end-to-end (shown in FIG. 3 as, “link 2”) connection between the cellular network 106 and the UE device 104, where a first portion of the end-to-end connection is between the cellular network 106 and the UE device 102 over the air interface connection 113-1, and a second portion of the end-to-end connection is between the UE device 102 and the UE device 104 over the sidelink connection 119.

At operation 412, the cellular network 106 transmits a message (labeled in FIG. 4 as, “Sub-Slice Establish Accept”) to the UE device 102 indicating that the network sub-slice 118-1a is established for the UE device 104. The Sub-Slice Establish Accept at operation 412 includes information indicating that the sub-slice is terminated at the UE 104.

At operation 414, the UE device 102 transmits a message (labeled in FIG. 4 as, “Sub-Slice Establish Accept”) to the UE device 104 indicating that the network sub-slice 118-1a is established for the UE device 104. The Sub-Slice Establish Accept at operation 414 includes information indicating that the sub-slice is terminated at the UE 104.

FIG. 5 is a block diagram depicting an example environment for modifying a set of network slices for the sidelink UE device 104 to change from a network slice that uses a sidelink connection to another network slice that does not use the sidelink connection, according to some embodiments. Elements with the same reference numbers as previously introduced refer to the same or similar features, and FIG. 5 shows that the wireless device 104 includes an air interface 116 for directly communicating with the cellular network 106 when UE device's 104 capability to communicate with the cellular network 106 through the sidelink connection 119 degrades.

After establishing network slices for each of the UE device 102 (e.g., according to operations 280 in FIG. 2) and UE device 104 (e.g., according to operations 285 in FIG. 2 for a separate slice implementation or operations 485 in FIG. 4 for a sub-slice implementation), the UE device 104 determines, based on a change in a characteristic (e.g., a signal strength, a QoS, a packet error rate, latency, and/or a peak data rate requirement) of the sidelink connection, the timing for a modification of a set of network slices (e.g., network slice 118-2) for the UE device 104 in FIG. 1 to change from a network slice that uses a sidelink connection to another network slice that does not use the sidelink connection. For example, the UE device 104 may detect (e.g., via RSSI, RSRP, SINR, etc.) that the signal strength of the sidelink connection between the UE devices 102, 104 is below a predetermined threshold value to indicate that the signal is weak or weakening. In response, the UE device 102 transmits a message to the UE device 102 via the sidelink channel to request a modification of the set of network slices (e.g., network slice 118-2) for the UE device 104 to change from network slice 118-2 that uses the sidelink connection to another network slice that does not use the sidelink connection. The UE device 102, responsive to receiving the request from the UE device 104, transmits a message to the cellular network 106 to request a modification of the set of network slices (e.g., network slice 118-2) for the UE device 104 to change from network slice 118-2 that uses the sidelink connection to another network slice that does not use the sidelink connection. The cellular network 106 establishes network slice 118-4 for the UE device 104, where network slice 118-4 couples the UE device 104 to the cellular network 106 via link 3 over air interface connection 113-3 and without using the sidelink connection.

In some embodiments, the UE device 102, responsive to receiving the request from the UE device 104, transmits a message to the cellular network 106 to request a modification of the set of network slices for the UE device 104 to remove the sidelink connection, but keep the same (e.g., current) network slice for the UE device 104. The cellular network 106 moves, responsive to receiving the request, a control plane of the network slice 118-2 and a modification of the user plane of the network slice 118-2 to remove the sidelink connection, such that the network slice 118-2 now couples the UE device 104 to the cellular network 106 via link 4. As shown in FIG. 5, link 4 couples the UE device 104 to the cellular network 106 via the air interface (e.g., Uu interface 116) of the UE device 104 without using the sidelink connection. The cellular network 106 determines whether to create network slice 118-3 or network slice 118-4 by assessing the quality of the sidelink connection and its ability to meet the QoS/service level requirement for UE device 104.

Although FIG. 5 shows that the core network 110 establishes the network slice 118-2 to communicatively couple the UE device 104 to the cellular network 106 via link 2 and the sidelink connection, the core network 110 could instead establish a network sub-slice (e.g., network sub-slice 118-1a in FIG. 3) to communicatively couple the UE device 104 to the cellular network 106 via a link (e.g., link 2 in FIG. 3). The core network 110 could modify a set of network slices for the sidelink UE device 104 to change from the network sub-slice that uses a sidelink connection to another network slice that does not use the sidelink connection according to the above description of FIG. 5, but from the perspective of a network sub-slice instead of a separate network slice.

FIG. 6 is a signaling diagram depicting an example method of modifying a set of network slices for the sidelink UE device 104 in FIG. 5 to change from a network slice that uses a sidelink connection to another network slice that does not use the sidelink connection, according to some embodiments. The environment 600 includes the UE device 102, the UE device 104, the cellular network 106 in FIG. 5. At operation 601, the UE device 102 performs a control plane/user plane (CP/UP) message filtering and forwarding procedure according to operations 602-615. At operation 602, the cellular network 106 transmits a first control plane message to the UE device 102, where a first control plane message is targeted to network slice 118-1. At operation 603, the cellular network 106 transmits a second control plane message to the UE device 1-2, where the second control plane message is targeted to the network slice 118-2. At operation 605, the UE device 102 filters-out the second control plane message that targets the network slice 118-2. At operation 607, the UE device 102 determines that the cellular network 106 has established the network slice 118-2 for the UE device 104, and forwards the second control plane message to the UE device 104 via the sidelink connection.

At operations 609, the cellular network 106 transmits a first user plane message to the UE device 102, where the first user plane message targets the network slice 118-1. At operation 609-1 (not shown in FIG. 6), the UE device 102 determines that the cellular network 106 has established the network slice 118-1 for the UE device 102, and prevents the first user plane message from being forwarded to the UE device 104. At operations 611, the cellular network 106 transmits a second user plane message to the UE device 102, where the second user plane message targets the network slice 118-2. At operation 613, the UE device 102 determines that the cellular network 106 has established the network slice 118-2 for the UE device 104, and forwards the second user plane message to the UE device 104 via the sidelink connection.

At operation 614, the UE device 104 transmits a third message (e.g., user plane or control plane) to the UE device 102. The third message indicates that the third message is intended for the cellular network 106. At operation 615, the UE device 102 forwards the third message to the cellular network 106 over the network slice 118-2.

At operation 616, the UE device 104 detects that a signal associated with the sidelink connection is weak or is weakening based on a signal strength indicator, such as SS-RSRP (synchronization signal-reference signal received power), CSI-RSRP, NR-RSSI (new radio-received signal strength indicator), CSI-RSSI, SS-RSRQ (synchronization signal-reference signal received quality), CSI-RSRQ, SS-SINR (synchronization signal-signal to interference noise ratio), CSI-SINR, RSSI, RSRP, and SINR. At operation 633, the UE device 104 performs a slice modification procedure according to operations 617-624. At operation 617, the UE device 104 transmits a message (labeled in FIG. 6 as, “Slice Modification Request”) to the UE device 102 to request a modification of the set of network slices (e.g., network slice 118-2) for the UE device 104 to change from a network slice that uses a sidelink connection to another network slice that does not use the sidelink connection. At operation 618, the UE device 102 transmits a message (labeled in FIG. 6 as, “NAS Registration Request”) to the cellular network 106 to request a modification of the set of network slices for the UE device 104 to change from a network slice that uses a sidelink connection to another network slice that does not use the sidelink connection. At operation 620, the cellular network 106 allocates resources of the cellular network 106 for a control plane and a user plane for network slice 118-2, which communicatively couples the UE device 104 to the cellular network 106 via link 3 in FIG. 5 and without using the sidelink channel.

At operation 622, the cellular network 106 transmits a message to the UE device 102, where the message indicates a configuration update of a control plane and a user plane for network slice 118-2 to remove the sidelink connection. At operation 624, the UE device 102 transmits a message to the UE device 104, where the message indicates a configuration update of the control plane and the user plane for network slice 118-2 to remove the sidelink connection.

At operation 626, the cellular network 106 transmits a control plane message to the UE device 104 over the network slice 118-2 via link 3, which communicatively couples the UE device 104 to the cellular network 106 via link 3 in FIG. 5 and without using the sidelink channel. At operation 628, the cellular network 106 transmits a user plane message to the UE device 104 over the network slice 118-2 via link 3. At operation 630, the UE device 104 transmits a control plane message to the cellular network 106 over the network slice 118-2 via link 3. At operation 632, the UE device 104 transmits a user plane message to cellular network 106 over the network slice 118-2 via link 3.

Meanwhile network slice 1 continues to provide the same class of service to the UE device 102.

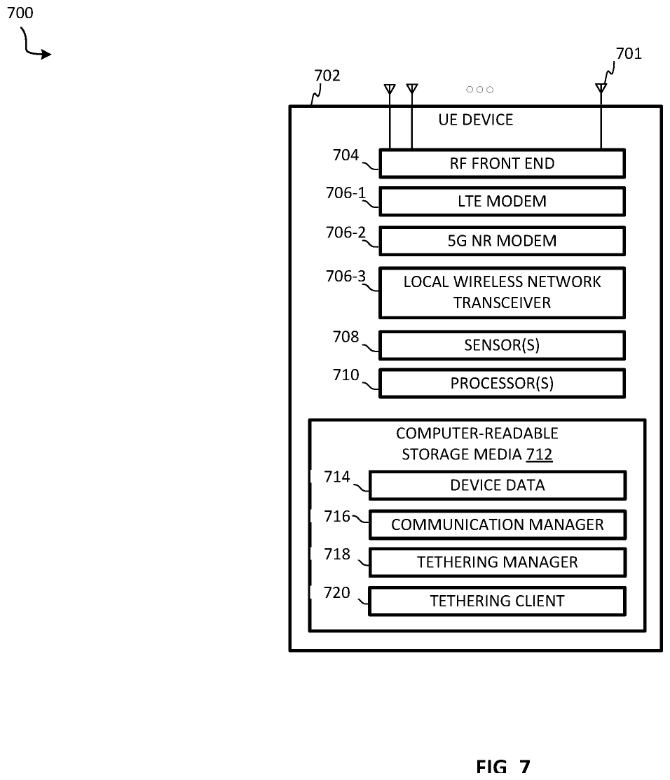

FIG. 7 is a block diagram depicting an example device diagram 700 of a UE device 702 (e.g., UE device 102, UE device 104), according to some embodiments. The device diagram 700 describes a UE device that can implement various aspects of network slices of a cellular network. The UE device 702 may include additional functions and interfaces that are omitted from FIG. 7 for the sake of clarity. The UE device 702 includes antennas 701, a radio frequency (RF) front end 704, and one or more RF transceivers 706 (e.g., a 3GPP Fourth Generation (4G) Long Term Evolution (LTE) transceiver 706-1 and a 5G NR transceiver 706-2) for communicating with a base station 112 in a RAN 108 in FIG. 1, such as a 5G RAN and/or an E-UTRAN. One antenna array may be used for cellular signaling and (optionally) another antenna array may be used for wireless communication across a sidelink connection. The UE device 702 (e.g., UE device 102) includes one or more additional transceivers 706-3, such as a local wireless network transceiver, for communicating over one or more local wireless networks (e.g., WLAN, Bluetooth, Near-Field Communication (NFC), a personal area network (PAN), Wireless Fidelity Direct (Wi-Fi-Direct), IEEE 802.15.4, ZigBee, Thread, mm Wave, and the like) with other UE devices 702 (e.g., UE device 104), such as those in a wirelessly tethered configuration with the UE device 702. The RF front end 704 couples or connects the LTE transceiver 706-1, the 5G NR transceiver 706-2, and the local wireless network transceiver 706-3 to the antennas 701 to facilitate various types of wireless communication.

The antennas 701 of the UE device 702 include an array of multiple antennas configured similar to or different from each other. The antennas 701 and the RF front end 704 are tuned to, and/or can be tunable to, one or more frequency bands, such as those defined by the 3GPP LTE, 3GPP 5G NR, IEEE WMAN, or other communication standards. The antennas 701, the RF front end 704, the LTE transceiver 706-1, the 5G NR transceiver 706-2, and/or the local wireless network transceiver 706-3 are configured to support beamforming (e.g., analog, digital, or hybrid), or in-phase and quadrature (I/Q) operations (e.g., I/Q modulation or demodulation operations) for the transmission and reception of communications with the base station 112. By way of example, the antennas 701 and the RF front end 704 operate in sub-gigahertz bands, sub-6 GHz bands, and/or above 6 GHz bands defined by the 3GPP LTE, 3GPP 5G NR, or other communication standards.

Using at least a portion of the antennas 701, the UE device 702 can form beams that are steered or un-steered, wide or narrow, or shaped (e.g., as a hemisphere, cube, fan, cone, or cylinder). The one or more transmitting antennas may have an un-steered omnidirectional radiation pattern or may be able to produce a wide steerable beam.

The UE device 702 includes one or more sensors 708 implemented to detect various properties such as temperature, supplied power, power usage, battery state, or the like. The sensors 708 can include any one or a combination of temperature sensors, thermistors, battery sensors, and power usage sensors. The UE device 702 uses the various properties to determine whether the UE device 702 has the capability to connect to the cellular network 106 over its air interface, or if the UE device 702 only has enough resources (e.g., battery power, etc.) to connect to the cellular network 106 using a sidelink connection to another UE device.

The UE device 702 also includes at least one processor 710 and a non-transitory computer-readable storage media 712 (CRM 712). The computer-readable storage media described herein excludes propagating signals. The CRM 712 includes any suitable memory or storage device such as random-access memory (RAM), static RAM (SRAM), dynamic RAM (DRAM), non-volatile RAM (NVRAM), read-only memory (ROM), or Flash memory useable to store device data 714 of the UE device 702. The device data 714 includes, for example, user data, multimedia data, beamforming codebooks, applications, and/or an operating system of the UE device 702, which are executable by the processor 710 to enable user-plane communication, control-plane signaling, and user interaction with the UE device 702.

The CRM 712 includes a communication manager 716. Alternatively, or additionally, the communication manager 716 is implemented in whole or part as hardware logic or circuitry integrated with or separate from other components of the UE device 702. The communication manager 716 configures the RF front end 704, the LTE transceiver 706-1, the 5G NR transceiver 706-2, and/or the local wireless network transceiver 706-3 to perform one or more wireless communication operations.

The CRM 712 further includes a tethering manager 718 and a tethering client 720. Alternately, or additionally, one or more of these components, in at least some embodiments, are implemented in whole or part as hardware logic or circuitry integrated with or separate from other components of the UE device 702. The tethering manager 718 configures the RF front end 704, the transceiver(s) 706, processor 710, and/or other components of the UE device 702 to implement the techniques described herein with respect to the UE device 102. The tethering client 720 configures the RF front end 704, the transceiver(s) 706, processor 710, and/or other components of the UE device 702 to implement the techniques described herein with respect to the UE device 104. The tethering manager 718 and the tethering client 720 allow the UE device 702 is use wireless or wired tethering technology to establish a connection with a cellular network through another device.

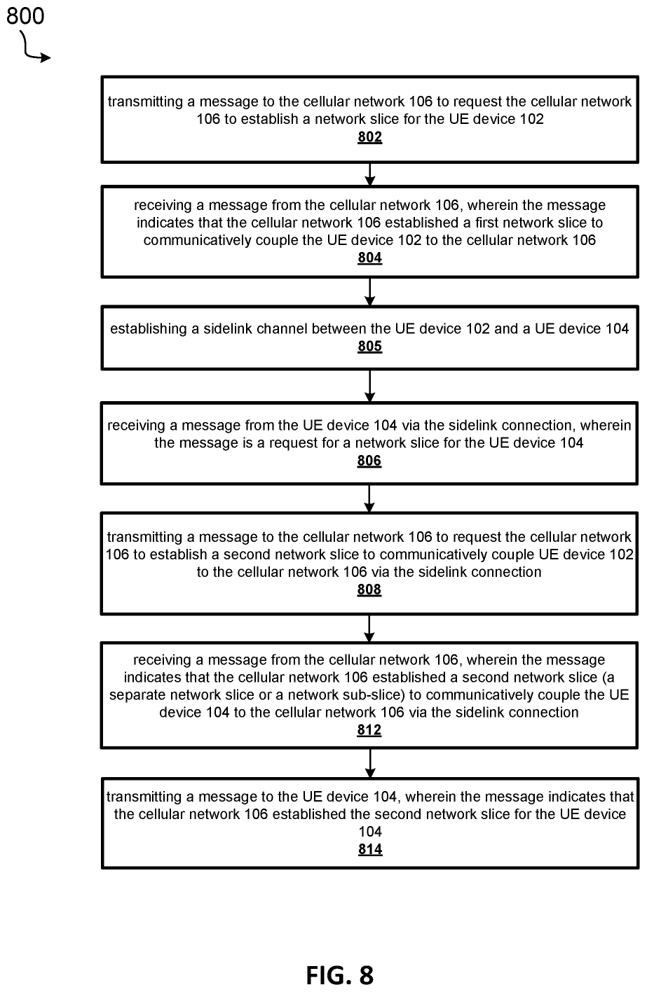

FIG. 8 is a flow diagram depicting a method for implementing network slicing by a host UE device, according to some embodiments. Method 800 is performed by processing logic that includes hardware (e.g., circuitry, dedicated logic, programmable logic, a processor, a processing device, a central processing unit (CPU), a system-on-chip (SoC), etc.), software (e.g., instructions and/or an application that is running/executing on a processing device), firmware (e.g., microcode), or a combination thereof. The method 800 is performed by a host UE device, such as host UE device 102.

With reference to FIG. 8, method 800 illustrates example functions used by various embodiments. Although specific function blocks (“blocks”) are disclosed in method 800, such blocks are examples. That is, embodiments are well suited to performing various other blocks or variations of the blocks recited in method 800. It is appreciated that the blocks in method 800 may be performed in an order different than presented, and that not all of the blocks in method 800 may be performed.

As shown in FIG. 8, the method 800 includes the block 802 of transmitting a message to the cellular network 106 to request the cellular network 106 to establish a network slice for the UE device 102. The method 800 includes the block 804 of receiving a message from the cellular network 106, wherein the message indicates that the cellular network 106 established a first network slice (e.g., network slice 118-1 in FIG. 1) to communicatively couple the UE device 102 to the cellular network 106. The method 800 includes the block 805 of establishing a sidelink channel between the UE device 102 and a UE device 104.

The method 800 includes the block 806 of receiving a message from the UE device 104 via the sidelink connection, wherein the message is a request for a network slice for the UE device 104. The method 800 includes the block 808 of transmitting a message to the cellular network 106 to request the cellular network 106 to establish a second network slice to communicatively couple UE device 102 to the cellular network 106 via the sidelink connection. The method 800 includes the block 812 of receiving a message from the cellular network 106, wherein the message indicates that the cellular network 106 established a second network slice (e.g., network slice 118-2 in FIG. 1 or network sub-slice 118-1a in FIG. 3) to communicatively couple the UE device 104 to the cellular network 106 via the sidelink connection. The method 800 includes the block 814 of transmitting a message to the UE device 104, wherein the message indicates that the cellular network 106 established the second network slice for the UE device 104.

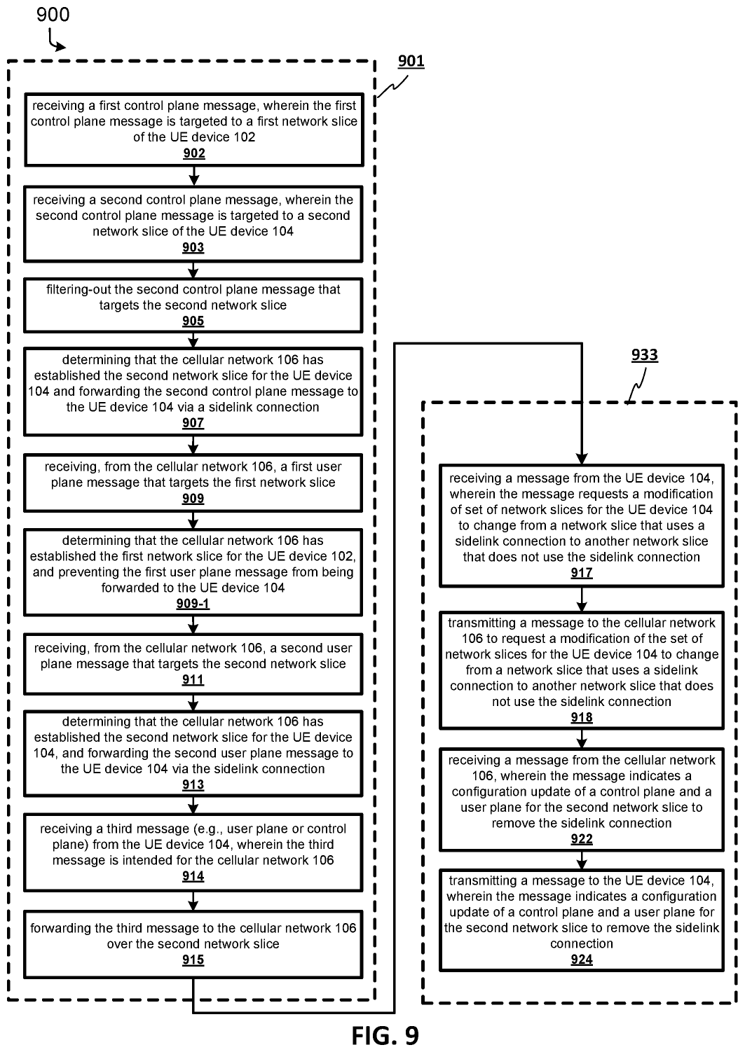

FIG. 9 is a flow diagram depicting a method for implementing network slicing by a host UE device, according to some embodiments. Method 900 is performed by processing logic that includes hardware (e.g., circuitry, dedicated logic, programmable logic, a processor, a processing device, a central processing unit (CPU), a system-on-chip (SoC), etc.), software (e.g., instructions and/or an application that is running/executing on a processing device), firmware (e.g., microcode), or a combination thereof. The method 900 is performed by a host UE device, such as host UE device 102.

With reference to FIG. 9, method 900 illustrates example functions used by various embodiments. Although specific function blocks (“blocks”) are disclosed in method 900, such blocks are examples. That is, embodiments are well suited to performing various other blocks or variations of the blocks recited in method 900. It is appreciated that the blocks in method 900 may be performed in an order different than presented, and that not all of the blocks in method 900 may be performed.

As shown in FIG. 9, the method 900 includes the block 901 of performing a control plane/user plane (CP/UP) message filtering and forwarding procedure according to operations 902-915. The method 900 includes the block 902 of receiving a first control plane message, wherein the first control plane message is targeted to a first network slice of the UE device 102. The method 900 includes the block 903 of receiving a second control plane message, wherein the second control plane message is targeted to a second network slice of the UE device 104. The method 900 includes the block 905 of filtering-out the second control plane message that targets the second network slice. The method 900 includes the block 907 of determining that the cellular network 106 has established the second network slice for the UE device 104 and forwarding the second control plane message to the UE device 104 via a sidelink connection.

The method 900 includes the block 909 of receiving, from the cellular network 106, a first user plane message that targets the first network slice. The method 900 includes the block 909-1 of determining that the cellular network 106 has established the first network slice for the UE device 102, and preventing the first user plane message from being forwarded to the UE device 104.

The method 900 includes the block 911 of receiving, from the cellular network 106, a second user plane message that targets the second network slice. The method 900 includes the block 913 of determining that the cellular network 106 has established the second network slice for the UE device 104, and forwarding the second user plane message to the UE device 104 via the sidelink connection.

The method 900 includes the block 914 of receiving a third message (e.g., user plane or control plane) from the UE device 104, wherein the third message is intended for the cellular network 106. The method 900 includes the block 915 of forwarding the third message to the cellular network 106 over the second network slice.

The method 900 includes the block of 933 of performing a slice modification procedure according to operations 917-924. The method 900 includes the block 917 of receiving a message from the UE device 104, wherein the message requests a modification of set of network slices for the UE device 104 to change from a network slice that uses a sidelink connection to another network slice that does not use the sidelink connection. The method 900 includes the block 918 of transmitting a message to the cellular network 106 to request a modification of the set of network slices for the UE device 104 to change from a network slice that uses a sidelink connection to another network slice that does not use the sidelink connection.

The method 900 includes the block 922 of receiving a message from the cellular network 106, wherein the message indicates a configuration update of a control plane and a user plane for the second network slice to remove the sidelink connection. The method 900 includes the block 924 of transmitting a message to the UE device 104, wherein the message indicates a configuration update of a control plane and a user plane for the second network slice to remove the sidelink connection.

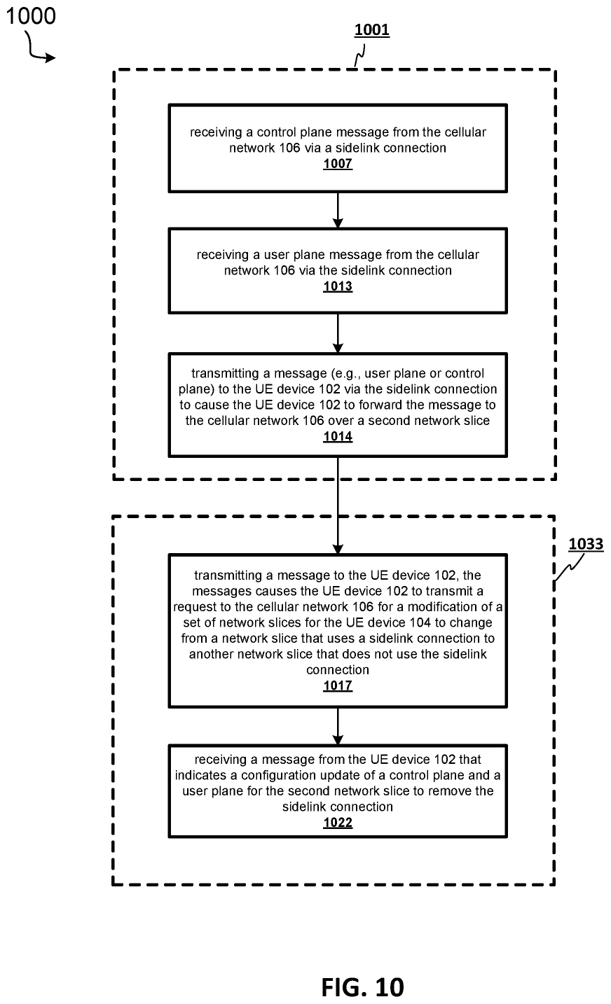

FIG. 10 is a flow diagram depicting a method for implementing network slicing by a sidelink wireless device 104, according to some embodiments. Method 1000 is performed by processing logic that includes hardware (e.g., circuitry, dedicated logic, programmable logic, a processor, a processing device, a central processing unit (CPU), a system-on-chip (SoC), etc.), software (e.g., instructions and/or an application that is running/executing on a processing device), firmware (e.g., microcode), or a combination thereof. The method 900 is performed by a sideline wireless device, such as sidelink UE device 104.

With reference to FIG. 10, method 1000 illustrates example functions used by various embodiments. Although specific function blocks (“blocks”) are disclosed in method 1000, such blocks are examples. That is, embodiments are well suited to performing various other blocks or variations of the blocks recited in method 1000. It is appreciated that the blocks in method 1000 may be performed in an order different than presented, and that not all of the blocks in method 1000 may be performed.

As shown in FIG. 10, the method 1000 includes the block 1001 of performing a control plane/user plane (CP/UP) message filtering and forwarding procedure according to operations 1007-1014. The method 1000 includes the block 1007 of receiving a control plane message from the cellular network 106 via a sidelink connection. The method 1000 includes the block 1013 receiving a user plane message from the cellular network 106 via the sidelink connection. The method 1000 includes the block 1014 of transmitting a message (e.g., user plane or control plane) to the UE device 102 via the sidelink connection to cause the UE device 102 to forward the message to the cellular network 106 over a second network slice.

The method 1000 includes the block of 1033 of performing a slice modification procedure according to operations 1017 and 1022. The method 1000 includes the block 1017 of transmitting a message to the UE device 102, the messages causes the UE device 102 to transmit a request to the cellular network 106 for a modification of a set of network slices for the UE device 104 to change from a network slice that uses a sidelink connection to another network slice that does not use the sidelink connection. The method 1000 includes the block 1022 of receiving a message from the UE device 102 that indicates a configuration update of a control plane and a user plane for the second network slice to remove the sidelink connection.

Unless specifically stated otherwise, terms such as “establishing,” “receiving,” “transmitting,” or the like, refer to actions and processes performed or implemented by computing devices that manipulates data represented as physical (electronic) quantities within the computing device's registers and memories into other data similarly represented as physical quantities within the computing device memories or registers or other such information storage, transmission or display devices. Also, the terms “first,” “second,” “third,” “fourth,” etc., as used herein are meant as labels to distinguish among different elements and may not necessarily have an ordinal meaning according to their numerical designation.

Examples described herein also relate to an apparatus for performing the operations described herein. This apparatus may be specially constructed for the required purposes, or it may include a general purpose computing device selectively programmed by a computer program stored in the computing device. Such a computer program may be stored in a computer-readable non-transitory storage medium.

The methods and illustrative examples described herein are not inherently related to any particular computer or other apparatus. Various general purpose systems may be used in accordance with the teachings described herein, or it may prove convenient to construct more specialized apparatus to perform the required method steps. The required structure for a variety of these systems will appear as set forth in the description above.

The above description is intended to be illustrative, and not restrictive. Although the present disclosure has been described with references to specific illustrative examples, it will be recognized that the present disclosure is not limited to the examples described. The scope of the disclosure should be determined with reference to the following claims, along with the full scope of equivalents to which the claims are entitled.

As used herein, the singular forms “a”, “an” and “the” are intended to include the plural forms as well, unless the context clearly indicates otherwise. It will be further understood that the terms “comprises”, “comprising”, “includes”, and/or “including”, when used herein, specify the presence of stated features, integers, steps, operations, elements, and/or components, but do not preclude the presence or addition of one or more other features, integers, steps, operations, elements, components, and/or groups thereof. Therefore, the terminology used herein is for the purpose of describing particular embodiments only and is not intended to be limiting.

It should also be noted that in some alternative implementations, the functions/acts noted may occur out of the order noted in the figures. For example, two figures shown in succession may in fact be executed substantially concurrently or may sometimes be executed in the reverse order, depending upon the functionality/acts involved.

Although the method operations were described in a specific order, other operations may be performed in between described operations, described operations may be adjusted so that they occur at slightly different times or the described operations may be distributed in a system which allows the occurrence of the processing operations at various intervals associated with the processing.

Various units, circuits, or other components may be described or claimed as “configured to” or “configurable to” perform a task or tasks. In such contexts, the phrase “configured to” or “configurable to” is used to connote structure by indicating that the units/circuits/components include structure (e.g., circuitry) that performs the task or tasks during operation. As such, the unit/circuit/component can be said to be configured to perform the task, or configurable to perform the task, even when the specified unit/circuit/component is not currently operational (e.g., is not on). The units/circuits/components used with the “configured to” or “configurable to” language include hardware—for example, circuits, memory storing program instructions executable to implement the operation, etc. Reciting that a unit/circuit/component is “configured to” perform one or more tasks, or is “configurable to” perform one or more tasks, is expressly intended not to invoke 35 U.S.C. § 112, sixth paragraph, for that unit/circuit/component. Additionally, “configured to” or “configurable to” can include generic structure (e.g., generic circuitry) that is manipulated by software and/or firmware (e.g., an FPGA or a general-purpose processor executing software) to operate in manner that is capable of performing the task(s) at issue. “Configured to” may also include adapting a manufacturing process (e.g., a semiconductor fabrication facility) to fabricate devices (e.g., integrated circuits) that are adapted to implement or perform one or more tasks. “Configurable to” is expressly intended not to apply to blank media, an unprogrammed processor or unprogrammed generic computer, or an unprogrammed programmable logic device, programmable gate array, or other unprogrammed device, unless accompanied by programmed media that confers the ability to the unprogrammed device to be configured to perform the disclosed function(s).

The foregoing description, for the purpose of explanation, has been described with reference to specific embodiments. However, the illustrative discussions above are not intended to be exhaustive or to limit the present disclosure to the precise forms disclosed. Many modifications and variations are possible in view of the above teachings. The embodiments were chosen and described in order to best explain the principles of the embodiments and its practical applications, to thereby enable others skilled in the art to best utilize the embodiments and various modifications as may be suited to the particular use contemplated. Accordingly, the present embodiments are to be considered as illustrative and not restrictive, and the present disclosure is not to be limited to the details given herein, but may be modified within the scope and equivalents of the appended claims.

In the following some embodiments are disclosed in the form of examples.

Example 1: A method, by a first user equipment (UE), comprising:
establishing a sidelink connection with a second UE;
receiving, from the second UE via the sidelink connection, a first request for a network slice of a physical network; and
transmitting, responsive to receiving the first request for the network slice, a first message to the physical network over a first network slice between the first UE and the physical network to request the physical network to establish a second network slice communicatively coupling the second UE to the physical network via the sidelink connection.

Example 2: The method of Example 1, wherein the first request comprises information indicative of at least one of a quality of service (QOS) characteristic or a sidelink connection characteristic.

Example 3. The method of Example 2, wherein the sidelink connection characteristic comprises information indicative of at least one of a delay of the sidelink connection, a data rate of the sidelink connection, or a packet loss rate of the sidelink connection.

Example 4. The method of Example 1, wherein the first request comprises an indication regarding the second network slice.

Example 5. The method of Example 4, further comprising:
determining, based on the indication, whether to request the physical network to establish the second network slice as a separate network slice from the first network slice or as a sub-slice of the first network slice.

Example 6. The method of Example 4 or 5, further comprising:
transmitting, based on the indication, the first message to the physical network over the first network slice to request the network to establish the second network slice for the second UE as a separate network slice from the first network slice.

Example 7. The method of any of Examples 4 to 6, wherein the indication comprises an indicator of a preference for the separate network slice.

Example 8. The method of any of Examples 4 to 7, wherein the indicator is a single network slice selection assistance information (S-NSSAI).

Example 9. The method of Example 4 or 5, further comprising:
transmitting, based on the indicator, the first message to the physical network over the first network slice to request the physical network to establish the second network slice for the second UE as a sub-slice of the first network slice.

Example 10. The method of any of Examples 4, 5, or 9, wherein the indication comprises an indicator of a preference for the sub-slice.

Example 11. The method of any of Examples 4, 5, 9, or 10, wherein the indicator is an absence of a single network slice selection assistance information (S-NSSAI).

Example 12. The method of any of Examples 4 to 11, wherein the indication comprises an indicator of a device type identifier.

Example 13. The method of any of Examples 2 to 4 or 9 to 12, wherein the indication is associated with at least one of a peak data rate no greater than a peak data rate of the first network slice, a user-experience metric no greater than a user-experience metric of the first network slice, a latency no greater than a latency of the first network slice, or a mobility metric associated with the first network slice.

Example 14. The method of any of Examples 1-13, wherein the first network slice supports a first quality of service (QOS) flow and the second network slice supports a second Qos flow.

Example 15. The method of any of Examples 1-14, wherein the first QoS flow and the second QoS flow use a same set of parameters or a different set of parameters.

Example 16. The method of any of Examples 1-15, further comprising:
receiving, via the sidelink connection, a second request to release the second UE from the second network slice; and
transmitting a second message over the first network slice to request the physical network to modify the second network slice to release the second UE from the second network slice.

Example 17. The method of any of Examples 1-16, further comprising:
receiving, from the second UE via the sidelink connection, a third request to modify a set of network slices for the second UE; and
transmitting a third message to the physical network over the first network slice to request the physical network to modify a set of network slices for the second UE to request the physical network to establish a third network slice communicatively coupling the second UE to the physical network via the sidelink connection.

Example 18. The method of any of Examples 1-17, further comprising:
receiving, from the physical network, a first non-access stratum message associated with the first network slice and a second non-access stratum message associated with the second network slice; and
redirecting the second non-access stratum message to the second UE via the sidelink connection without redirecting the first non-access stratum message to the second UE.

Example 19. The method of Example 18, wherein the first non-access stratum message and the second non-access stratum message are each associated with a control plane message or a user plane message.

Example 20. The method of any of Examples 1-19, further comprising:
receiving, from the second UE via the sidelink connection, a second request to modify a set of network slices for the second UE to change from the second network slice that uses the sidelink connection to a third network slice that does not use the sidelink connection; and
transmitting a third message to the physical network over the first network slice to request the physical network to modify a set of network slices for the second UE to change from the second network slice that uses the sidelink connection to the third network slice that does not use the sidelink connection.

Example 21. The method of Example 20, wherein the third message further comprising:
(a) a request to move a control plane of the second network slice to the third network slice, or
(b) a request to remove the sidelink connection from a user plane of the second network slice.

Example 22. The method of Example 20 or 21, further comprising:
receiving, from the physical network over the second network slice, a fourth message comprising a configuration update including configuration information of the third network slice; and
transmitting, to the second UE via the sidelink connection, the configuration information for the second UE to use when communicating with the physical network over the third network slice.

Example 23. The method of any of Examples 20 or 22, wherein the third network slice is a separate network slice from the first network slice.

Example 24. The method of any of Examples 20 or 22, wherein the third network slice communicatively couples the second UE to the physical network via an air interface of the second UE without using the sidelink connection.

Example 25. A method, by a second user equipment (UE), comprising:
establishing a sidelink connection with a first UE;
transmitting, to the first UE via the sidelink connection, a first request for a network slice of the physical network; and
receiving, from the first UE via the sidelink connection, an indication of a second network slice communicatively coupling the second UE to the physical network via the sidelink connection.

Example 26. The method of Example 25, further comprising:
measuring a parameter associated with the sidelink connection;
determining, based on the parameter associated with the sidelink connection, a timing for a modification of a set of network slices for the second UE to change from the second network slice that uses the sidelink connection to another network slice that does not use the sidelink connection;
transmitting, to the first UE via the sidelink connection, a second request to modify the set of network slices for the second UE to change from the second network slice that uses the sidelink connection to another network slice that does not use the sidelink connection; and
receiving, from the first UE via the sidelink connection, an indication that the network established a third network slice for the second UE, the third network slice connects the second UE to the network via an air interface of the second UE.

Example 27. The method of Example 26, wherein the parameter comprises at least one of a received signal strength indicator (RSSI) value, a reference signal received quality (RSRQ) value, or a signal to interference noise ratio (SINR) value.

Example 28. The method of Example 26, further comprising:
transmitting a third request to move a control plane of the second network slice to the third network slice, or
transmitting a third request to remove the sidelink connection from a user plane of the second network slice.

Example 29. The method of Example 26, wherein the third network slice is a separate network slice from the first network slice or a sub-slice of the first network slice.

Example 30. The method of Example 26, wherein the third network slice communicatively couples the second UE to the physical network via an air interface of the second UE without using the sidelink connection.

Example 31. A user equipment (UE), comprising:
one or more radio frequency (RF) modems;
a processor coupled to the one or more RF modems; and
at least one memory storing executable instructions, the executable instructions to manipulate at least one of the processor or the one or more RF modems to perform the method of any of Examples 1-30.

What is claimed is:

1. A method, by a first user equipment, UE, comprising:
receiving, from a second UE via a sidelink connection, a first request for a first network slice of a physical network; and
transmitting, to the physical network over the first network slice, a second request to establish a second network slice communicatively coupling the second UE to the physical network via the sidelink connection.

2. The method of claim 1, the first request comprising an indication regarding the second network slice, the indication specifying at least one of a quality of service (QOS) characteristic or a sidelink connection characteristic, the sidelink connection characteristic comprising at least one of a delay of the sidelink connection, a data rate of the sidelink connection, or a packet loss rate of the sidelink connection.

3. The method of claim 2, further comprising:
determining, based on the indication, whether to request the physical network to establish the second network slice as a separate network slice from the first network slice or as a sub-slice of the first network slice, wherein the sub-slice of the first network slice is separate from other network sub-slices within the first network slice and separate from the other network slices of the physical network.

4. The method of claim 2, further comprising:
transmitting, based on the indication, a first message to the physical network over the first network slice to request the network to establish the second network slice for the second UE as a separate network slice from the first network slice.

5. The method of claim 2, further comprising:
transmitting, based on the indication, a first message to the physical network over the first network slice to request the physical network to establish the second network slice for the second UE as a sub-slice of the first network slice.

6. The method of claim 2, wherein the indication is associated with at least one of a peak data rate no greater than a peak data rate of the first network slice, a user-experience metric no greater than a user-experience metric of the first network slice, a latency no greater than a latency of the first network slice, or a mobility metric associated with the first network slice.

7. The method of claim 1, further comprising:
receiving, via the sidelink connection, a third request to release the second UE from the second network slice; and
transmitting a second message over the first network slice to request the physical network to modify the second network slice to release the second UE from the second network slice.

8. The method of claim 1, further comprising:
receiving, from the second UE via the sidelink connection, a fourth request to modify a set of network slices for the second UE; and
transmitting a third message to the physical network over the first network slice to request the physical network to modify a set of network slices for the second UE to request the physical network to establish a third network slice communicatively coupling the second UE to the physical network via the sidelink connection.

9. The method of claim 1, further comprising:
receiving, from the second UE via the sidelink connection, a fifth request to modify a set of network slices for the second UE to change from the second network slice that uses the sidelink connection to a third network slice that does not use the sidelink connection; and
transmitting, to the physical network over the first network slice, a third message to request the physical network to modify a set of network slices for the second UE to change from the second network slice that uses the sidelink connection to the third network slice that does not use the sidelink connection, wherein the third network slice communicatively couples the second UE to the physical network via an air interface of the second UE without using the sidelink connection.

10. The method of claim 9, wherein the third message further comprising:
a request to move a control plane of the second network slice to the third network slice, or a request to remove the sidelink connection from a user plane of the second network slice.

11. The method of claim 9, further comprising:
receiving, from the physical network over the second network slice, a fourth message comprising a configuration update including configuration information of the third network slice; and
transmitting, to the second UE via the sidelink connection, the configuration information for the second UE to use when communicating with the physical network over the third network slice.

12. A method, by a second user equipment, UE, comprising:
transmitting, to a physical network, a first request for a first network slice of the physical network;
transmitting, to the physical network over the first network slice, a second request to establish a second network slice communicatively coupling the second UE to the physical network; and
receiving, from the physical network, an indication of the second network slice communicatively coupling the second UE to the physical network.

13. The method of claim 12, further comprising:
receiving, from the physical network, an indication of a third network slice communicatively coupling the second UE to the physical network without a sidelink connection between the second UE and a first UE;
measuring a parameter associated with the sidelink connection;
transmitting, to the physical network via the sidelink connection with the first UE, a third request for the second UE to change from the second network slice that uses the sidelink connection to the third network slice that does not use the sidelink connection, wherein the parameter comprises at least one of a received signal strength indicator (RSSI) value, a reference signal received quality (RSRQ) value, or a signal to interference noise ratio (SINR) value.

14. The method of claim 13, further comprising:
transmitting a fourth request to move a control plane of the second network slice to the third network slice, or
transmitting the fourth request to remove the sidelink connection from a user plane of the second network slice.

15. A first user equipment comprising:
one or more radio frequency, RF, modem;
a processor coupled to the one or more RF modems; and
at least one memory storing executable instructions, the executable instructions to manipulate at least one of the processor or the one or more RF modems to:
receive, from a second UE via a sidelink connection, a first request for a first network slice of a physical network; and
transmit, to the physical network over the first network slice, a second request to establish a second network slice communicatively coupling the second UE to the physical network via the sidelink connection.

16. The first UE of claim 15, the first request comprising an indication regarding the second network slice, the indication specifying at least one of a quality of service (QOS) characteristic or a sidelink connection characteristic, the sidelink connection characteristic comprising at least one of a delay of the sidelink connection, a data rate of the sidelink connection, or a packet loss rate of the sidelink connection.

17. The first UE of claim 16, wherein the at least one of the processor or the one or more RF modems to is further to:
determine, based on the indication, whether to request the physical network to establish the second network slice as a separate network slice from the first network slice or as a sub-slice of the first network slice, wherein the sub-slice of the first network slice is separate from other network sub-slices within the first network slice and separate from the other network slices of the physical network.

18. The first UE of claim 16, wherein the at least one of the processor or the one or more RF modems to is further to:
transmit, based on the indication, a first message to the physical network over the first network slice to request the network to establish the second network slice for the second UE as a separate network slice from the first network slice.

19. The first UE of claim 16, wherein the at least one of the processor or the one or more RF modems to is further to:
transmit, based on the indication, a first message to the physical network over the first network slice to request the physical network to establish the second network slice for the second UE as a sub-slice of the first network slice.

20. The first UE of claim 16, wherein the indication is associated with at least one of a peak data rate no greater than a peak data rate of the first network slice, a user-experience metric no greater than a user-experience metric of the first network slice, a latency no greater than a latency of the first network slice, or a mobility metric associated with the first network slice.
